(19) United States
(12) Patent Application Publication
(10) Pub. No.: US 2007/0211729 A1
(43) Pub. Date: Sep. 13, 2007

(54) Device authentication system

(75) Inventors: Harumine Yoshiba, Kanagawa (JP); Takeshi Chiba, Chiba (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/328,547

(22) Filed: Jan. 10, 2006

(30) Foreign Application Priority Data
Jan. 12, 2005 (JP) P.2005-005154

(51) Int. Cl. H04L 12/56

(52) U.S. Cl. 370/395.52

(57) ABSTRACT

A high level of security is realized by imposing limitations on an unauthorized communications device in establishing connection to a network, without involvement of an increase in the burden of network equipment such as a router or a communications device constituting a network. An address delivery section 103 in a router 101 delivers a link local address in answer to an address request from a communications device 111, and requests the communications device 111 to transmit authentication data. An equipment authentication section 102 in the router 101 authenticates the communications device 111 on the basis of the authentication data transmitted from the communications device 111, and reports an authentication result to the address delivery section 103. When the communications device 111 has been authenticated, the address delivery section 103 delivers a global address or a site local address to the communications device 111.

### BACKGROUND OF THE INVENTION

The present invention relates to a communications system for performing communication through use of an IPv6 network, a router constituting the communications system, a communications device, and a communications method.

A system for delivering an IP address to pieces of equipment, which establish connection with a network, through use of a DHCP (Dynamic Host Configuration Protocol), has recently become widespread. When the DHCP is used, all pieces of equipment (communications devices) connected to a network can acquire IP addresses and use the network, which poses a security problem. To address this problem, there has been proposed a DHCP server having a client authentication function which authenticates equipment by a MAC address; which delivers an IP address to the equipment that has been authorized; and which periodically verifies whether the equipment is authorized after delivery of the IP address, to thus prevent equipment, which is unauthorized and uses a false IP address, from effecting communication (see JP-A-2001-211180).

However, the related-art DHCP server encounters a problem of requiring periodic operation for verifying whether the equipment is authorized, resulting in an increase in the load imposed on the DHCP server. When data given a false MAC address are sent, there arises a problem of the DHCP server failing to determine whether the sender is authorized equipment.

### SUMMARY OF THE INVENTION

The present invention has been conceived in view of the above circumstance and aims at providing a communications system which realizes a high level of security by limiting connection of an unauthorized communications device with a network, without involvement of an increase in the load imposed on network equipment, such as a router and a communications device, constituting the network; as well as providing a router of that communications system, and a communications device.

A communications system of the present invention is a communications system which establishes communication through use of an IPv6 network, includes a router, and a communications device. The router includes an authentication unit for performing authentication upon receipt of authentication data from the communications device, a first address delivery unit for delivering a link local address to the communications device, and a second address delivery unit for delivering a global address or a site local address to the communications device when the communications device has been authenticated by the authentication unit. The communications device includes an address request unit for requesting the router to deliver an address, and an authentication data transmission unit for transmitting authentication data to the router.

By the above configuration, the router delivers a link local address in response to the request for delivery of an address issued by the communications device, authenticates the communications device on the basis of the authentication data transmitted from the communications device, and delivers a global address or a site local address to the communications device when the communications device has been authenticated. Since the global address or the site local address is delivered to the authenticated communications device, a high level of security can be realized.

A communications system of the present invention is a communications system which establishes communication through use of an IPv6 network, includes a router, and a communications device. The router includes an authentication unit for performing authentication upon receipt of authentication data from the communications device, and an address delivery unit which delivers a global address or a site local address to the communications device when the communications device is authenticated by the authentication unit and which delivers a link local address to the communications device when the communications device is not authenticated by the authentication unit. The communications device includes an address request unit for requesting the router to deliver an address; and an authentication data transmission unit for transmitting authentication data to the router.

By the above configuration, the router authenticates the communications device on the basis of the authentication data transmitted from the communications device. When the communications device has been authenticated, a global address or a site local address is delivered to the communications device. When the communications device has not been authenticated, a link local address is delivered to the communications device. Since the communications device is authenticated and a global address or a site local address is delivered to the authenticated communications device, a high level of security can be realized.

A communications system of the present invention is a communications system in which a router, a communications device, and an authentication station having a function of authenticating the communications device are connected by way of a hub and which establishes communication through use of an IPv6 network, includes a router, a communications device, an authentication station having a function of authenticating the communications device, and a connection section for connecting together the router, the communications device, and the authentication station. The router includes a first address delivery unit for delivering a link local address to the communications device, an authentication result receiving unit for receiving an authentication result of the communication device from the authentication station, and a second address delivery unit for delivering a global address or a site local address to the communications device when the authentication result is an approval of authentication. The communications device includes an address request unit for requesting the router to deliver an address; and an authentication data transmission unit for transmitting authentication data to the authentication station.

By the configuration, the router delivers the link local address to the communications device; the communications device transmits authentication data to the authentication station; and the router receives the authentication result of the communications device from the authentication station. When the result of authentication is an approval of an authentication, a global address or a site local address is delivered to the communications device. When the authentication station has authenticated the communications device, a global address or a site local address is delivered to the communications device, and hence a high level of security can be achieved.

A communications system of the present invention is a communications system includes a router connected to an IPv6 network; a communications device; and an authentication station connected to the router. The router includes a first address delivery unit for delivering a link local address to the communications device, an authentication data transfer unit for transferring, to the authentication station, authentication data which have been transmitted from the communications device through use of the link local address, and a second address delivery unit for delivering a global address or a site local address to the communications device when the authentication station has authenticated the communications device. The communications device includes an address request unit for requesting the router to deliver an address, and an authentication data transmission unit for transmitting authentication data to the router.

By the configuration, when the router transfers the authentication data, which have been transmitted from the communications device, to the authentication station and when the authentication station has authenticated the communications device, the router delivers a global address or a site local address to the communications device. Hence, a high level of security can be realized.

A router of the present invention is used in an IPv6 network and includes a first address delivery unit for delivering a link local address to a communications device connected to the IPv6 network; an authentication unit which receives authentication data from the communications device and performs authentication; and a second address delivery unit which delivers a global address or a site local address to the communications device when the authentication unit has authenticated the communications device.

By the above configuration, the router delivers a link local address in answer to the request for delivery of an address issued by the communications device; authenticates the communications device on the basis of the authentication data transmitted from the communications device; and delivers a global address or a site local address to the communications device when the communications device has been authenticated. Since the global address or the site local address is delivered to the authenticated communications device, a high level of security can be realized.

A router of the present invention is used in an IPv6 network and includes an authentication unit which receives authentication data from a communications device connected to the IPv6 network and performs authentication; and an address delivery unit which delivers a global address or a site local address to the communications device when the authentication unit has authenticated the communications device and which delivers a link local address to the communications device when the communications device has not been authenticated.

By the above configuration, the router authenticates the communications device. When the communications device has been authenticated, a global address or a site local address is delivered to the communications device. When the communications device has not been authenticated, a link local address is delivered to the communications device. Accordingly, a high level of security can be realized.

A router of the present invention is used in an IPv6 network and includes a first address delivery unit for delivering a link local address to a communications device connected to the IPv6 network; an authentication result receiving unit for receiving an authentication result pertaining to the communications device from an authentication station connected to the IPv6 network; and a second address delivery unit for delivering a global address or a site local address to the communications device when the authentication result is an approval of an authentication.

By the configuration, when the authentication station has authenticated the communications device, the router delivers a global address or a site local address to the communications device. Hence, a high level of security can be achieved.

A router of the present invention is used in an IPv6 network and includes a first address delivery unit for delivering a link local address to a communications device connected to the IPv6 network; an authentication data transfer unit for transferring, to an authentication station, authentication data which have been transmitted from the communications device through use of the link local address; and a second address delivery unit for delivering a global address or a site local address to the communications device when the authentication station has authenticated the communications device.

By the configuration, the router transfers the authentication data, which have been transmitted from the communications device, to the authentication station. When the authentication station has authenticated the communications device, the router delivers a global address or a site local address to the communications device, and hence a high level of security can be realized.

A communications method for a router according to the present invention is for causing a computer constituting a router used in an IPv6 network to implement a function of delivering a link local address to a communications device connected to the IPv6 network; an authentication function of authenticating the communications device; and a function of delivering a global address or a site local address to the communications device when the communications device has been authenticated by the authentication function.

A communications method for a router according to the present invention is for causing a computer constituting a router used in an IPv6 network to implement an authentication function of authenticating a communications device connected to the IPv6 network; and a function of delivering a global address or a site local address to the communications device when the communications device has been authenticated by the authentication function and delivering a link local address to the communications device when the communications device has not been authenticated.

A communications method for a router according to the present invention is for causing a computer constituting a router used in an IPv6 network to implement a function of delivering a link local address to a communications device connected to the IPv6 network; a function of receiving an authentication result pertaining to the communications device from an authentication station connected to the IPv6 network; and a function of delivering a global address or a site local address to the communications device when the authentication result is an approval of an authentication.

A communications method for a router according to the present invention is for causing a computer constituting a router used in an IPv6 network to implement a function of delivering a link local address to a communications device connected to the IPv6 network; a function of transferring, to an authentication station, authentication data that have been transmitted from the communications device by use of the link local address; and a function of delivering a global address or a site local address to the communications device when the authentication station has authenticated the communications device.

A communications method for a communications device according to the present invention is for causing a computer constitutes a communications device connected to an IPv6 network to implement a function of delivering a link local address when the communications device is connected to the IPv6 network and has not yet been authenticated and requesting a router to deliver an address wile a global address or a site local address when the communications device is authenticated; and a function of transmitting authentication data to the router.

A communications method for a communications device according to the present invention is for causing a computer constituting a communications device connected to an IPv6 network to implement a function of delivering a link local address when the communications device is connected to the IPv6 network and has not yet been authenticated and requesting a router, which delivers a global address or a site local address, to deliver an address when the communications device is authenticated; and a function of transmitting authentication data to an authentication station which authenticates the communications device.

According to the present invention, there can be provided a communications system which lessens the load imposed on equipment, which would be caused by periodic verification of equipment; which can be combined with arbitrary an authentication unit such as a public-key authentication scheme; and which can implement a high level of security, as well as providing a router and a communications device which constitute the communications system.

### BRIEF DESCRIPTION OF THE DRAWINGS

The object and advantages of the present invention will become more apparent from descriptions of a detailed explanation of a preferred embodiment by reference to the accompanying drawings, wherein

FIG. 1 is a block diagram showing the configuration of a communications system according to a first embodiment of the present invention;

FIG. 2 is a flowchart of operation of an equipment authentication section of a router in the communications system according to the first embodiment;

FIG. 3 is a flowchart of operation of an address delivery section of the router in the communications system according to the first embodiment;

FIG. 4 is a flowchart of operation of a data transceiving section of the router in the communications system according to the first embodiment;

FIG. 5 is a flowchart of operation of the data transceiving section of a communications device in the communications system according to the first embodiment;

FIG. 6 is a flowchart of operation of an authentication processing section of the communications device in the communications system according to the first embodiment;

FIG. 7 is a flowchart of operation of an address request section of the communications device in the communications system according to the first embodiment;

FIG. 8 is a block diagram showing the configuration of a communications system according to a second embodiment of the present invention;

FIG. 9 is a flowchart of operation of an address delivery section of a router in the communications system according to the second embodiment;

FIG. 10 is a block diagram showing the configuration of a communications system according to a third embodiment of the present invention;

FIG. 11 is a flowchart of operation of an address delivery section of a router in the communications system according to the third embodiment;

FIG. 12 is a flowchart of operation of a data transceiving section of the router in the communications system according to the third embodiment;

FIG. 13 is a flowchart of operation of the data transceiving section of the communications device in the communications system according to the third embodiment;

FIG. 14 is a block diagram showing the configuration of a communications system according to a fourth embodiment of the present invention;

FIG. 15 is a flowchart of operation of an address delivery section of a router in the communications system according to the fourth embodiment;

FIG. 16 is a flowchart of operation of a data transceiving section of the router in the communications system according to the fourth embodiment;

FIG. 17 is a block diagram showing the configuration of a communications system according to a fifth embodiment of the present invention;

FIG. 18 is a flowchart of operation of a data transceiving section of the router in the communications system according to the fifth embodiment; and

FIG. 19 is a flowchart of operation of the data transceiving section of the communications device in the communications system according to the fifth embodiment.

### DETAILED DESCRIPTION OF PREFERRED EMBODIMENTS

### First Embodiment

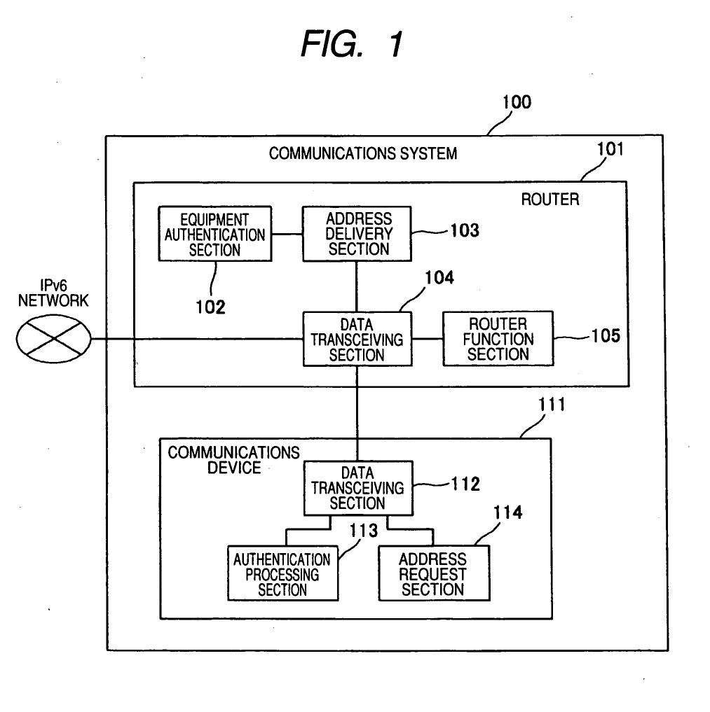

FIG. 1 is a block diagram showing the configuration of a communications system according to a first embodiment of the present invention. A communications system 100 shown in FIG. 1 is configured so that a router 101 is connected to a communications device 111 using an IPv6 network, through the IPv6 network.

The router 101 includes an equipment authentication section 102 having the function of authenticating the communications device 111; an address delivery section 103 having the function of delivering an IP address to the communications equipment 111; a data transceiving section 104 having the function of transmitting and receiving data by way of the IPv6 network; and a router function section 105 having the function of an existing router, such as determination of a destination of data. The equipment authentication section 102 corresponds to an authentication unit which authenticates a communications device. The address delivery section 103 corresponds to a first address delivery unit for delivering a link local address and a second address delivery unit for delivering a global address or a site local address.

The communications device 111 includes a data transceiving section 112 having the function of transmitting and receiving data over the IPv6 network; an authentication processing section 113 for transmitting previously-recorded authentication data; and an address request section 114 having the function of requesting an IP address. The authentication processing section 113 corresponds to an authentication data transmission unit which transmits authentication data to a router; and the address request section 114 corresponds to an address request unit which requests delivery of an address to the router.

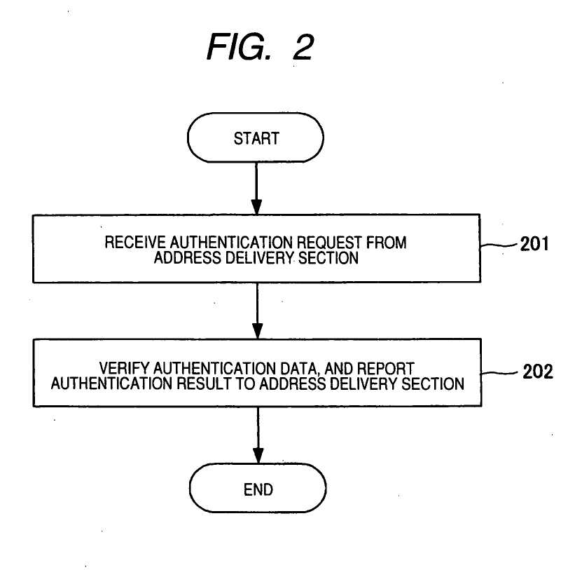

First, detailed operation of the router 101 will be described by use of flowcharts shown in FIGS. 2 through 4. FIG. 2 is a flowchart showing operation of the equipment authentication section 102 of the router 101. The equipment authentication section 102 executes a loop consisting of the following processing. First, the equipment authentication section 102 receives, from the address delivery section 103, an authentication request and authentication data which pertain to the communications equipment 111 (step 201). The received authentication data are verified, and the result of verification is reported to the address delivery section (step 202). The authentication technique used herein is of, e.g., a public-key authentication scheme. In this case, the authentication data correspond to data into which a predetermined pass phrase is encrypted by a secret key. When the encrypted data are decrypted by a public key having been delivered to the equipment authentication section 102 beforehand, authentication is completed so long as a coincidence exists between the pass phrases.

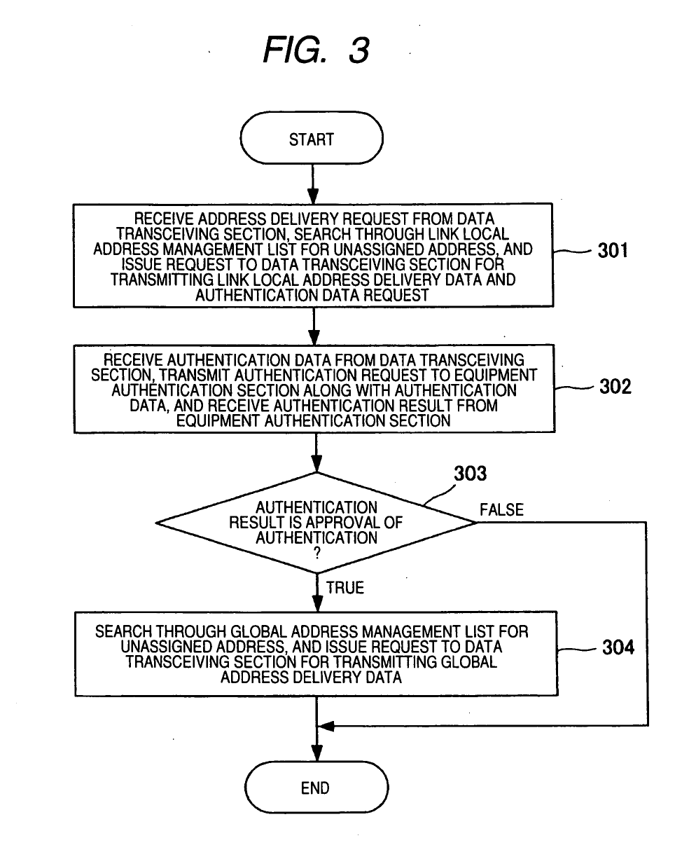

FIG. 3 is a flowchart showing operation of the address delivery section 103 of the router 101. The address delivery section 103 executes a loop consisting of the following processing. First, the address delivery section 103 receives an address delivery request from the data transceiving section 104; searches through an unillustrated link local address management list for an unassigned address; and requests the data transceiving section 104 to transmit link local address delivery data and an authentication data request (step 301).

Next, the address delivery section 103 receives, from the data transceiving section 104, the authentication data transmitted from the communications device 111 in response to the authentication data request; transmits the authentication request to the equipment authentication section 102 along with the authentication data; and receives the result of authentication from the equipment authentication section 102 (step 302).

A determination is made as to whether or not the result of authentication received from the equipment authentication section 102 is authorized (authorization is approved) (step 303). When the result of determination made in step 303 is true, a search is made through the unillustrated global address management list for an unassigned address, and a request is sent to the data transceiving section 104 for transmitting global address delivery data (step 304). When the result of determination in step 303 is false, nothing is performed.

When the result of determination rendered in step 303 is true, a search may be made through an unillustrated site local address management list for an unassigned address, and a request may be sent to the data transceiving section 104 for transmitting the site local address delivery data.

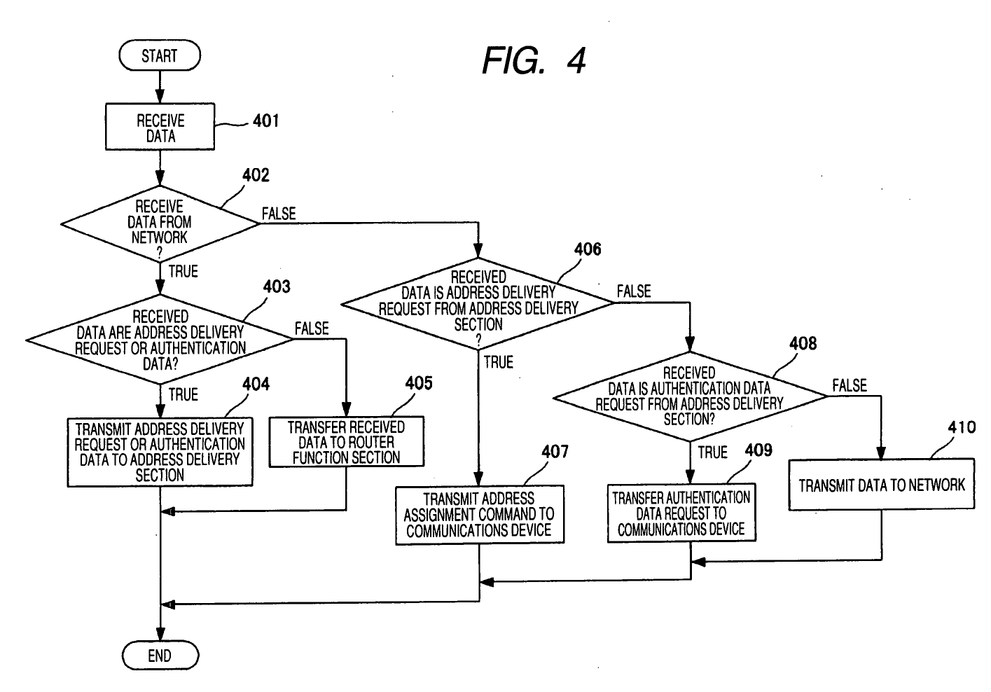

FIG. 4 is a flowchart showing operation of the data transceiving section 104 of the router 101. The data transceiving section 104 performs a loop consisting of the following processing. First, the data transceiving section 104 receives data (step 401). A determination is then made as to whether or not the data are sent from the communications device 111 of the network (step 402). When the result of determination made in step 402 is true, a determination is made as to whether or not the received data are an address delivery request sent from the communications device 111 or authentication data sent from the communications device 111 (step 403). When the result of determination rendered in step 403 is true, the address delivery request or authentication data are transmitted to the address delivery section 103 (step 404). When the result of determination rendered in step 403 is false, the data received from the network are transferred to the router function section 105, where there is performed existing router processing such as determination of another device in the network as a destination of transfer (step 405).

When the result of determination rendered in step 402 is false, a determination is made as to whether or not the received data are a request from the address delivery section 103 to the communications device 111 for delivering an address (step 406). When the result of determination rendered in step 406 is true, an address assignment command is transmitted to the communications device 111 by way of the network (step 407). When the result of determination rendered in step 406 is false, a determination is made as to whether or not the received data are an authentication data request issued from the address delivery section 103 (step 408). When the result of determination rendered in step 408 is true, the authentication data request is transferred to the communications device 111 (step 409). When the result of determination rendered in step 408 is false, the received data originate from the router function section 105, and the data are transferred to a destination specified by the router function section 105 (data are sent to the network) (step 410).

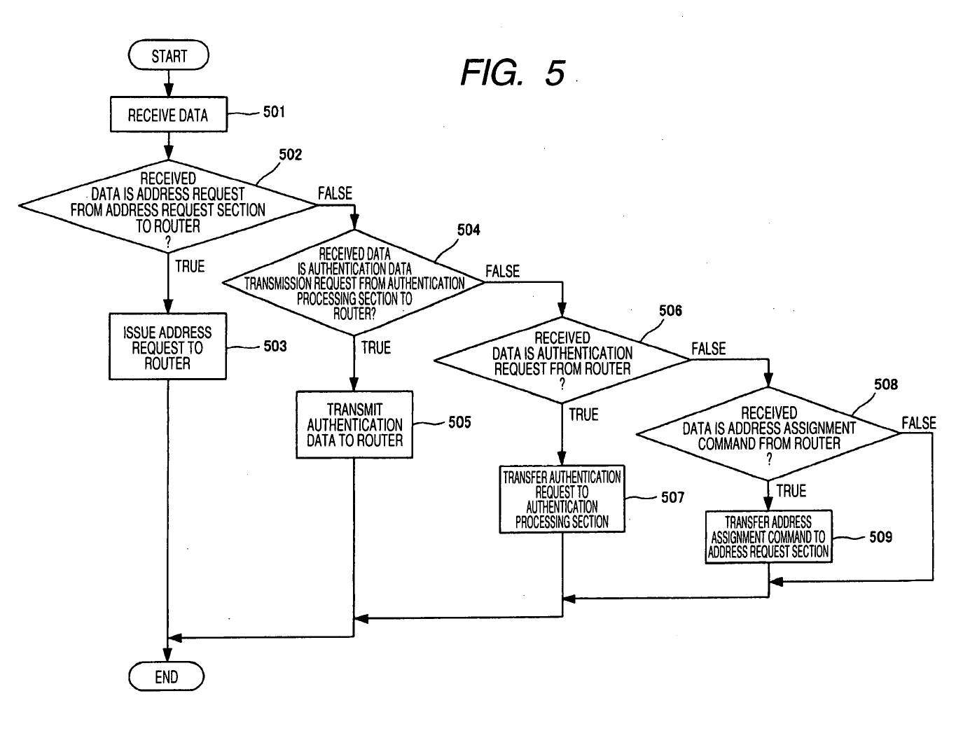

Detailed operation of the communications device 111 will now be described by reference to the flowcharts shown in FIGS. 5 through 7. FIG. 5 is a flowchart showing operation of the data transceiving section 112 of the communications device 111. The data transceiving section 112 performs a loop consisting of the following processing. First, the data transceiving section 112 receives data (step 501).

A determination is made as to whether or not the data received in step 501 are an address request issued from the address request section 114 to the router 101 (step 502). When the result of determination rendered in step 502 is true, the address request is transferred to the router 101 (step 503). When the result of determination rendered in step 502 is false, a determination is made as to whether or not the received data are a request issued from the authentication processing section 113 to the router 101 for transmitting authentication data (step 504). When the result of determination rendered in step 504 is true, authentication data are transmitted to the router 101 (step 505).

When the result of determination rendered in step 504 is false, a determination is made as to whether or not the received data are an authentication request from the router 101 (step 506). When the result of determination rendered in step 506 is true, the authentication request (authentication demand) is transferred to the authentication processing section 113 (step 507). When the result of determination rendered in step 506 is false, a determination is made as to whether or not the received data are an address assignment command output from the router 101 (step 508). When the result of determination rendered in step 508 is true, the address assignment command is transferred to the address request section 114 (step 509). An address is assigned to the communications device 111 by an address assignment command. When the result of determination rendered in step 509 is false, nothing is performed.

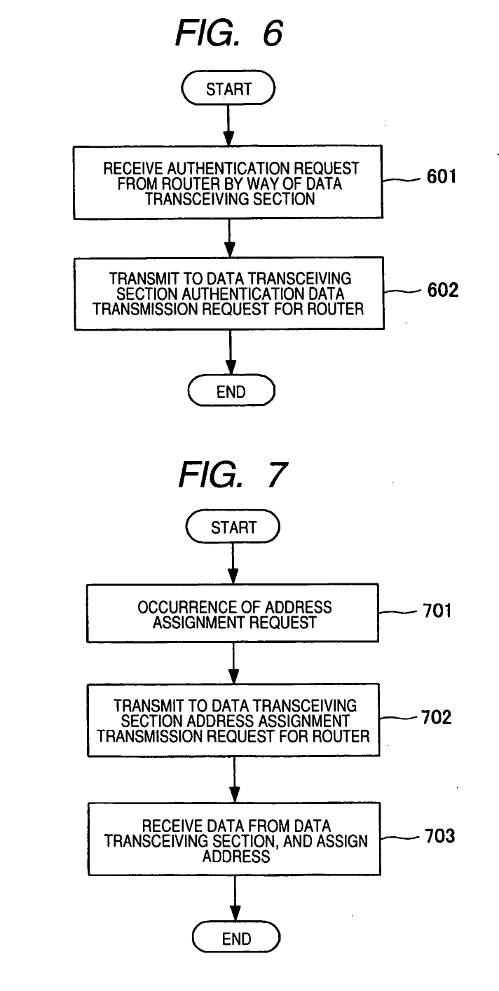

FIG. 6 is a flowchart showing operation of the authentication processing section 113 of the communications device 111. The authentication processing section 113 performs a loop consisting of the following processing. First, the authentication processing section 113 receives an authentication request, which has originated from the router 101, from the data transceiving section 112 (step 601). An authentication data transmission request for the router 101 is transmitted to the data transceiving section 112 (step 602). Thereby, the previously-recorded authentication data are transmitted to the router 101 by way of the data transceiving section 112.

FIG. 7 is a flowchart showing operation of the address request section 114 of the communications device 111. The address request section 114 performs a loop consisting of the following processing. First, the address request section 114 receives an address assignment request occurrence event (step 701). Next, the address assignment transmission request for the router 101 is transmitted to the data transceiving section 112 (step 702). Next, data transmitted from the data transceiving section 112 are received, and an address is assigned (step 703).

In the communications system 100 shown in FIG. 1, the router 101 first delivers a link local address in response to the address request transmitted from the communications device 111, and a request is sent to the communications device 111 for transmitting authentication data. Upon receipt of the link local address delivered by the router 101, the communications device 111 transmits the authentication data to the router 101. The router 101 has the equipment authentication section 102 for authenticating the communications device 111. On the basis of the authentication data transmitted from the communications device 111, the communications device 111 is authenticated. When the communications device 111 has been authenticated, a global address or a site local address is delivered to the communications device 111. Consequently, the authenticated (verified) communications device 111 can receive the delivery of a global address or a site local address from the router 101. Communication beyond the router 101 can be established by use of the thus-delivered global address or site local address. When the communications device 111 is not authenticated, the communications device 111 can receive only the delivery of the link local address, and hence limitations are imposed on the communications device 111 in establishing communication beyond the router 101.

### Second Embodiment

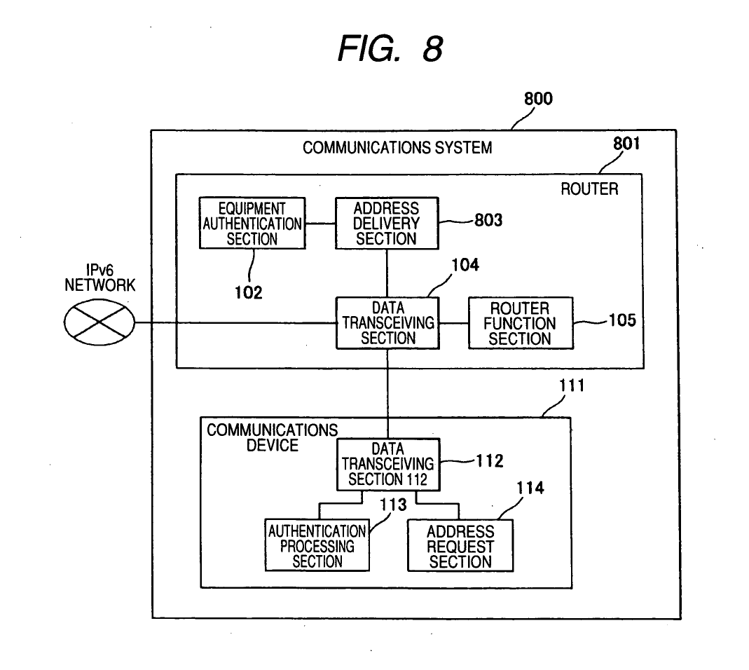

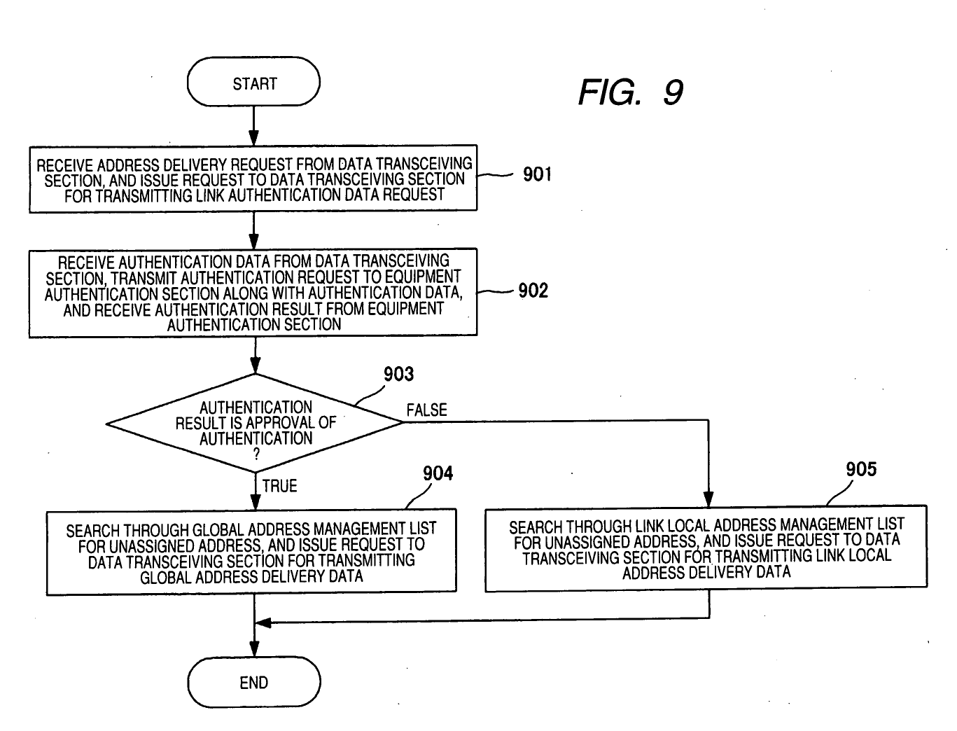

FIG. 8 is a block diagram showing the configuration of a communications system according to a second embodiment of the present invention. A communications system 800 shown in FIG. 2 is constituted as the result of a router 801 being connected to the communications device 111 using an IPv6 network, by the IPv6 network.

The router 801 includes the equipment authentication section 102 having the function of authenticating the communications device 111; an address delivery section 803 having the function of delivering an IP address to the communications equipment 111; the data transceiving section 104 having the function of transmitting and receiving data by way of the IPv6 network; and the router function section 105 having the function of an existing router, such as determination of a destination of data. The router 801 differs from the router 101 described in the first embodiment in terms of the address delivery section 803.

The communications device 111 includes the data transceiving section 112 having the function of transmitting and receiving data over the IPv6 network; the authentication processing section 113 for transmitting previously-recorded authentication data; and the address request section 114 having the function of requesting an IP address. The communications device 111 is identical with that of the communications system according to the first embodiment of the present invention, and hence its explanation is omitted.

Next, detailed operation of the router 801 will be described by use of a flowchart shown in FIG. 9. The equipment authentication section 102, the data transceiving section 104, and the router function section 105 are identical with those of the first embodiment of the present invention, and hence their explanations are omitted.

FIG. 9 is a flowchart showing operation of the address delivery section 803 of the router 801. The address delivery section 803 performs a loop consisting of the following processing. First, when the address delivery section 803 receives an address delivery request from the data transceiving section 104, a request is made to the data transceiving section 104 for transmitting authentication data (step 901). Next, upon receipt of the authentication data from the data transceiving section 104, an authentication request is transmitted to the equipment authentication section 102 along with authentication data, and the result of authentication is received from the equipment authentication section 102 (step 902).

A determination is made as to whether or not the result of authentication received in step 902 shows that the equipment is authenticated (authentication is approved) (step 903). When the result of authentication rendered in step 903 is true, a search is made through the global address management list for an unassigned address, and a request is made to the data transceiving section 104 for transmitting the global address delivery data (step 904). When the result of determination rendered in step 903 is true, a search may be made through the site local address management list for an unassigned address, and a request may be sent to the data transceiving section 104 for transmitting the side local address delivery data.

When the result of determination rendered in step 903 is false, a search is made through the link local address management list for an unassigned address. A request is sent to the data transceiving section 104 for transmitting the link local address delivery data (step 905).

In the communications system 800 shown in FIG. 8, upon receipt of an address request from the communications device 111, the router 801 requests the communications device 111 to transmit authentication data, and the communications device 111 is authenticated on the basis of the authentication data transmitted from the communications device 111. When the communications device 111 has been authenticated, the router 801 delivers the global address or the site local address. When the communications device 111 is not authenticated, the router 801 delivers the link local address. Consequently, the authenticated (normal) communications device 111 can receive the delivery of the global address or the site local address from the router 801. Communication beyond the router 801 can be performed by use of the delivered global address or site local address. When the communications device 111 is not authenticated, the communications device 111 can receive only the delivery of the link local address. Hence, limitations are imposed on the communications device 111 in establishing communication beyond the router 801.

### Third Embodiment

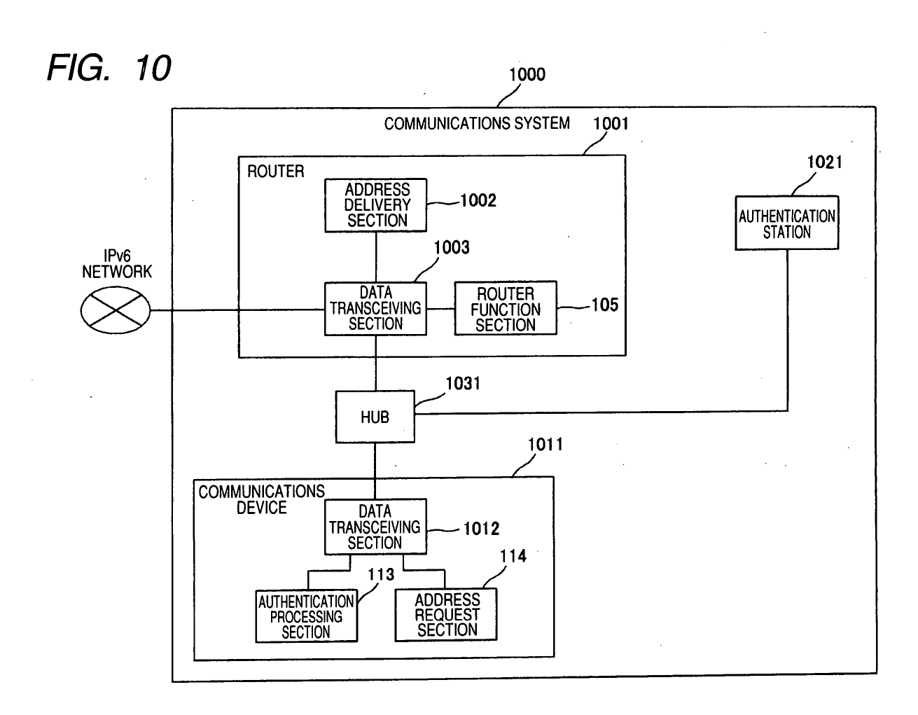

FIG. 10 is a block diagram showing the configuration of a communications system according to a third embodiment of the present invention. A communications system 1000 shown in FIG. 10 is constituted as the result of a hub 1031 being connected to a router 1001, a communications device 1011, and an authentication station 1021 by the IPv6 network.

The router 1001 includes an address delivery section 1002 having the function of delivering an IP address to the communications device 1011; a data transceiving section 1003 having the function of transmitting and receiving data over the IPv6 network; and the router function section 105 having the function of an existing router, such as determination of a destination of data. The router function section 105 has the same function as does the counterpart section in the first embodiment of the present invention.

The communications device 1011 includes a data transceiving section 1012 having the function of transmitting and receiving data over the IPv6 network; the authentication processing section 113 having the function of transmitting previously-recorded authentication data; and the address request section 114 having the function of processing for requesting an IP address. The authentication processing section 113 and the address request section 114 have the same functions as do the counterpart sections in the first embodiment.

When having received the authentication request to the communications device 1011 transmitted from the router 1001 (i.e., an authentication request from the router), the authentication station 1021 transmits an authentication request to the communications device 1011 for transmitting authentication data (i.e., an authentication request from the authentication station). The authentication station 1021 has the function of authenticating the communications device 1011 on the basis of the authentication data transmitted from the communications device 1011, and transmitting the result of authentication to the router 1001.

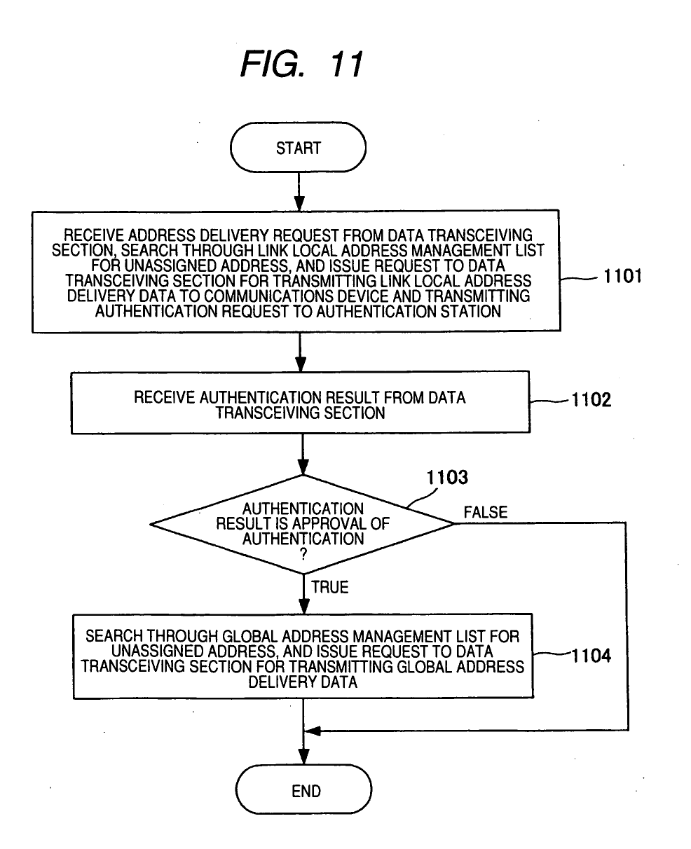

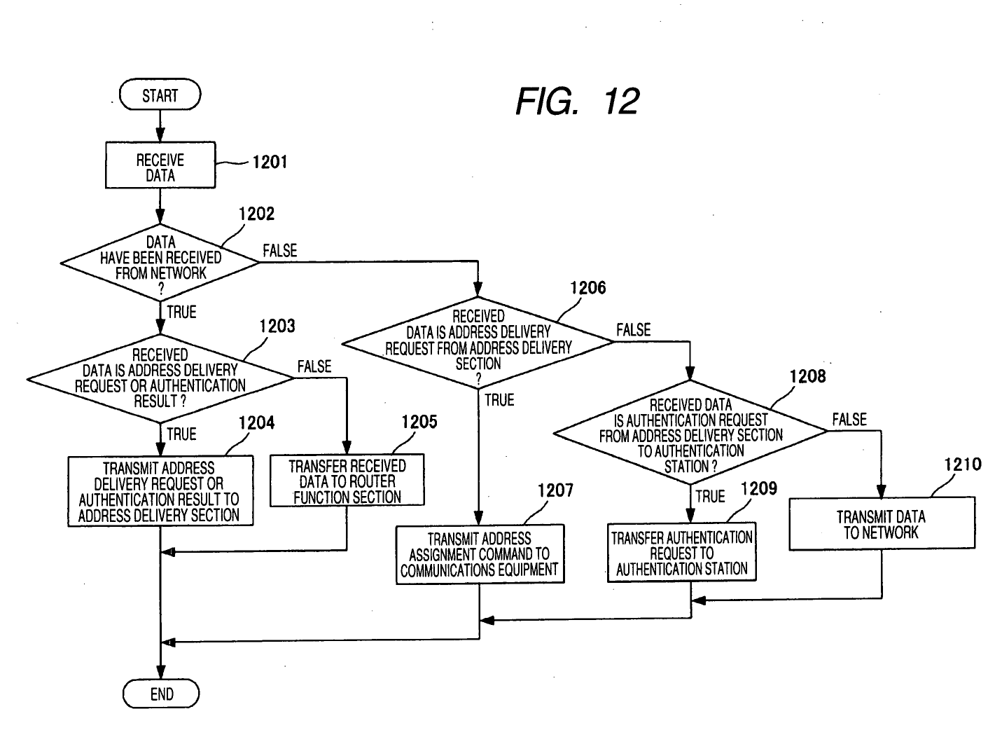

First, the detailed operation of the router 1001 will be described by use of flowcharts shown in FIGS. 11 and 12. FIG. 11 is a flowchart showing operation of the address delivery section 1002 of the router 1001.

The address delivery section 1002 performs a loop consisting of the following processing. First, when having received the address delivery request from the data transceiving section 1003, the address delivery section 1002 makes a search through the unillustrated link local address management list for an unassigned address; and makes a request to the data transceiving section for transmitting the link local address delivery data to the communications device. Further, a transmission request is made to the data transceiving section to transmit an authentication request to the authentication station (step 1101).

Next, an authentication result is received from the transceiving section (step 1102). A determination is made as to whether or not the authentication result is an approval of authentication (step 1103). When the result of determination rendered in step 1103 is true, a search is made through the unillustrated global address management list for an unassigned address, and a request is sent to the data transceiving section 1003 for transmitting the global address delivery data (step 1104). When the result of determination rendered in step 1103 is true, a search may be made through the unillustrated site local address management list for an unassigned address, and a request may be sent to the data transceiving section 1003 to transmit the site local address delivery data. When the result of determination rendered in step 1103 is false, nothing is performed.

FIG. 12 is a flowchart showing operation of the data transceiving section 1003. The data transceiving section 1003 first receives data (step 1201). Next, a determination is made as to whether or not the received data are received from equipment in the network (step 1202). A determination is made as to whether or not the data received in step 1202 are an address delivery request or an authentication result (step 1203). When the result of determination rendered in step 1203 is true, the address delivery request or the authentication result is transmitted to the address delivery section 1002 (step 1204). When the result of determination rendered in step 1203 is false, data are transferred to the router function section 105 (step 1205).

When the result of determination rendered in step 1202 is false, a determination is made as to whether or not the received data are an address delivery request sent from the address delivery section 1002 (step 1206). When the result of determination rendered in step 1206 is true, an address assignment command is transmitted to the communications device 1011 (step 1207). When the result of determination rendered in step 1206 is false, a determination is made as to whether or not the received data are the authentication request transmitted from the address delivery section 1002 to the authentication station 1201 (step 1208). When the result of determination rendered in step 1208 is true, the authentication request is transferred to the authentication station 1021 (step 1209). When the result of determination rendered in step 1208 is false, the received data are transmitted to other equipment in the network (step 1210).

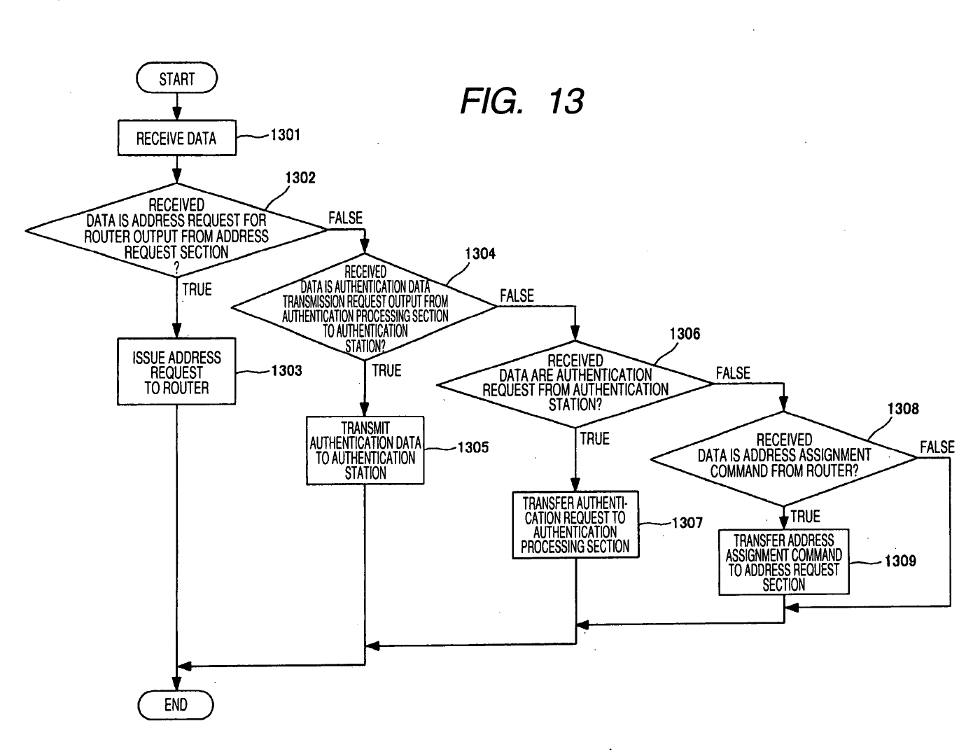

Detailed operation of the communications device 1011 will now be described. FIG. 13 is a flowchart showing operation of the data transceiving section 1012 of the communications device 1011. The data transceiving section 1012 of the communications device 1011 first receives data (step 1301). Next, a determination is made as to whether or not the received data are an address request transmitted from the address request section 114 to the router 1001 (step 1302). When the result of determination rendered in step 1302 is true, an address request is issued to the router 1001 (step 1303). When the result of determination rendered in step 1302 is false, a determination is made as to whether or not the received data are an authentication data transmission
request from the authentication processing section 113 to the authentication station 1021 (step 1304). When the result of determination rendered in step 1304 is true, authentication data are transmitted to the authentication station 1021 (step 1305).

When the result of determination rendered in step 1304 is false, a determination is made as to whether or not the received data are an authentication request from the authentication station 1021 (step 1306). When the result of determination rendered in step 1306 is true, an authentication request (an authentication request from the authentication station) is transmitted to the authentication processing section 113 (step 1307). When the result of determination rendered in step 1306 is false, a determination is made as to whether or not the received data are an address assignment from the router 1001 (step 1308). When the result of determination rendered in step 1308 is true, the received data are transferred to the address request section 114 (step 1309). When the result of determination rendered in step 1308 is false, nothing is performed.

In the communications system shown in FIG. 10, the router 1001 delivers a link local address to the communications device 1011 in response to the address delivery request from the communications device 1011, and the authentication request of the communications device 1011 is transmitted to the authentication station 1021. When having received the authentication request from the router 1001, the authentication station 1021 transmits an authentication request to the communications device 1011 to transmit authentication data (an authentication request from the authentication station). Upon receipt of the authentication request from the authentication station 1021, the communications device 1011 transmits the authentication data to the authentication station 1021. The authentication station 1021 receives authentication data transmitted from the communications device 1011; authenticates the communications device 1011 on the basis of the authentication data; and transmits the result of authentication to the router 1001. When the router 1001 has received the authentication result from the authentication station 1021 and the communications device 1011 has been authenticated, the global address or site local address is delivered to the communications device 1011. When the communications device 1011 has not been authenticated, the communications device 1011 can receive only the delivery of a link local address. Hence, limitations are imposed on the communications device 1011 in establishing communication beyond the router 1001.

### Fourth Embodiment

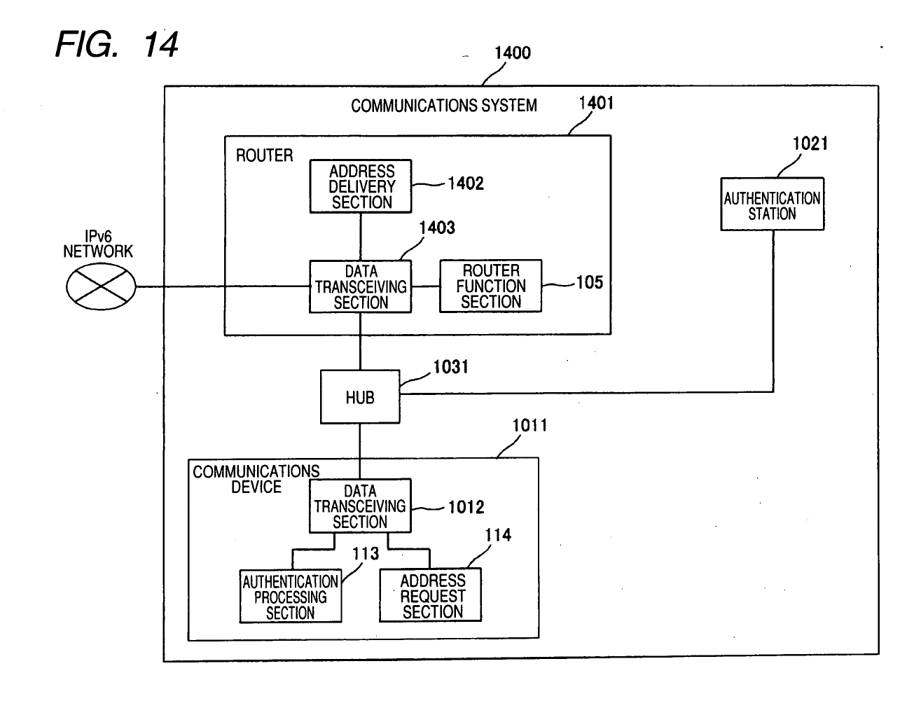

FIG. 14 is a block diagram showing the configuration of a communications system according to a fourth embodiment of the present invention. A communications system 1400 shown in FIG. 14 is constituted as the result of the hub 1031 being connected to a router 1401, the communications device 1011, and the authentication station 1021 by the IPv6 network.

The router 1401 includes an address delivery section 1402 having the function of delivering an IP address to the communications device 1011; a data transceiving section 1403 having the function of transmitting and receiving data over the IPv6 network; and the router function section 105 having the function of an existing router, such as determination of a destination of data. The router function section 105 has the same function as does the counterpart section in the first embodiment of the present invention. The communications device 1011, the authentication station 1021, and the hub 1031 have the same functions as do the counterparts in the third embodiment of the present invention.

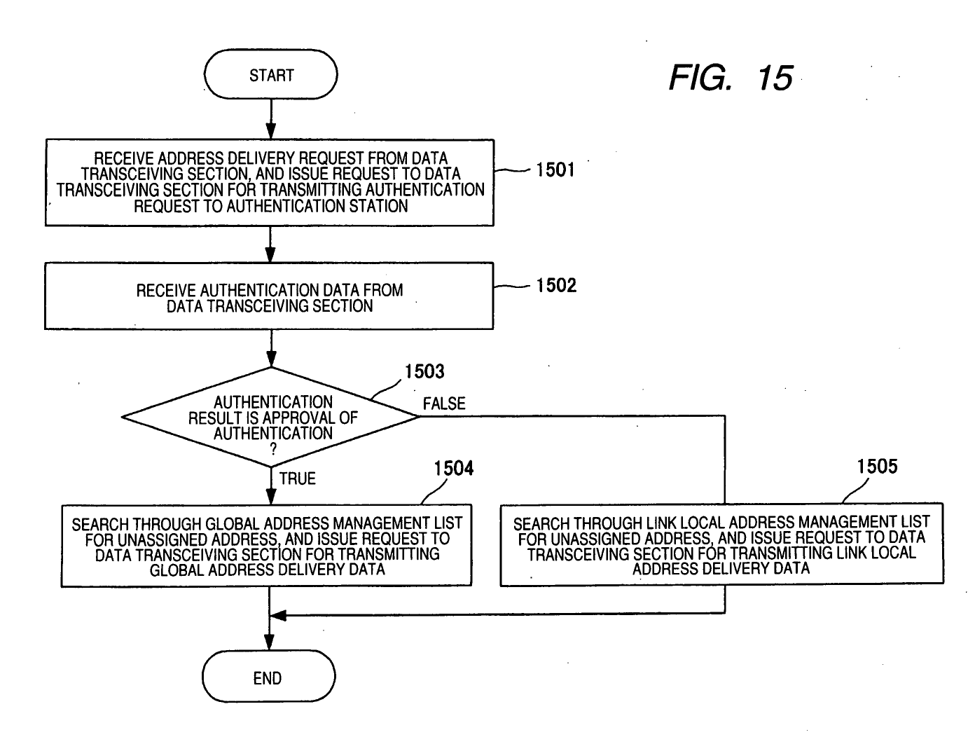

Detailed operation of the router 1401 will first be described. FIG. 15 is a flowchart showing operation of the address delivery section 1402 of the router 1401. The address delivery section 1402 executes a loop consisting of the following processing. The address delivery section 1402 receives an address delivery request from the data transceiving section 1403, and sends a request to the data transceiving section 1403 for transmitting an authentication request to the authentication station 1021 (step 1501). The authentication result, which has originally been transmitted from the authentication station 1021, is received from the data transceiving section 1403 (step 1502). A determination is made as to whether or not the authentication result received in step 1502 is the acceptance of authentication (step 1503). When the result of determination rendered in step 1503 is true, a search is made through the unillustrated global address management list for an unassigned address, and a request is sent to the data transceiving section 1403 for transmitting a global address delivery request (step 1504). When the result of determination rendered in step 1503 is false, a search is made through the unillustrated link local address management list for an unassigned address, and a request is sent to the data transceiving section 1403 for transmitting a link local address delivery request (step 1505). When the result of determination rendered in step 1503 is true, a search is made through the unillustrated site local management list for an unassigned address, and a request is sent to the data transceiving section 1403 for transmitting a site local address delivery request.

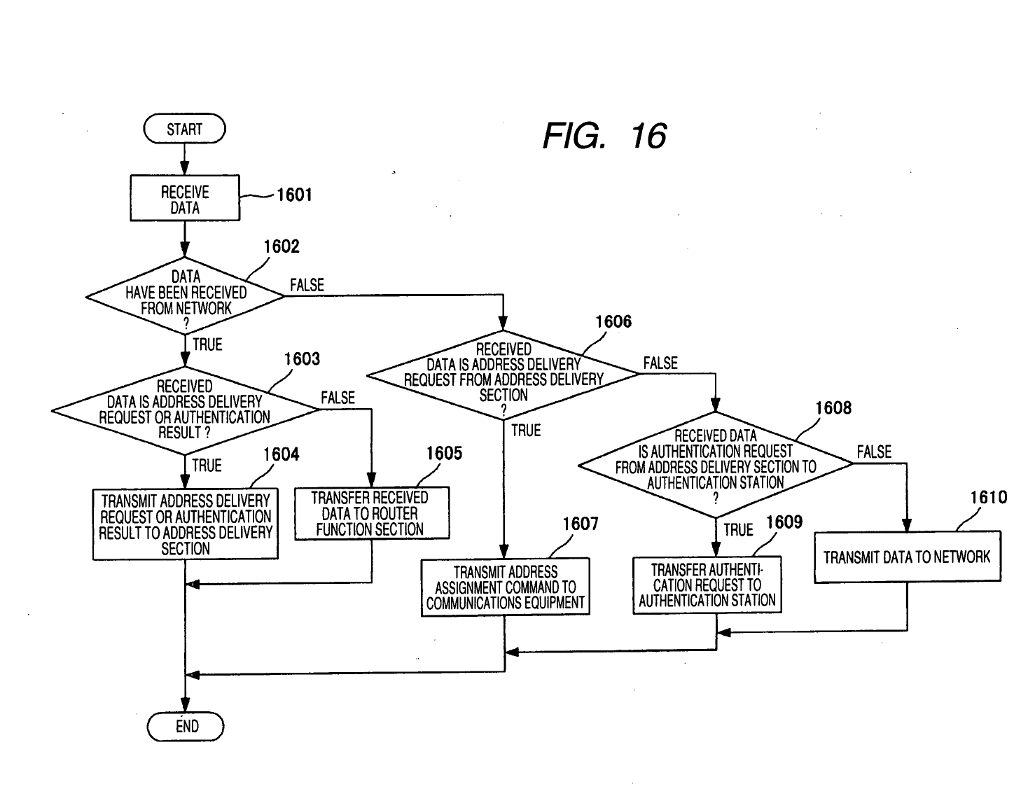

Operation of the data transceiving section 1403 of the router 1401 will now be described by reference to the flowchart shown in FIG. 16. The data transceiving section 1403 of the router 1401 executes a loop consisting of the following processing. First, the data transceiving section 1403 receives data (step 1601). Next, a determination is made as to whether or not the received data originate from the network (step 1602). When the result of determination rendered in step 1602 is true, a determination is made as to whether the received data are an address delivery request or an authentication result (step 1603). When the result of determination rendered in step 1603 is true, the address delivery request or the authentication result is transmitted to the address delivery section 1402 (step 1604). When the result of determination rendered in step 1603 is false, the received data are transferred to the router function section 105, where there is performed existing router processing such as determination of a destination in the network; namely, another device, (step 1605).

When the result of determination rendered in step 1602 is false, a determination is made as to whether or not the received data are an address delivery request issued by the address delivery section 1402 to the communications device 1011 (step 1606). When the result of determination rendered in step 1606 is true, an address assignment command is transmitted to the communications device 1011 by way of a network (step 1607). When the result of determination rendered in step 1606 is false, a determination is made as to whether or not the received data are an authentication request from the address delivery section 1402 to the authentication station 1021 (step 1608). When the result of determination rendered in step 1608 is true, the authentication request is transferred to the authentication station 1021 (STEP 1609). When the result of determination rendered in step 1608 is false, the received data originate from the router function section 105, and the data are transmitted to the destination specified by the router function section 105 (step 1610).

In the communications system shown in FIG. 14, upon having received the address delivery request from the communications device 1011, the router 1401 transmits, to the authentication station 1021, the request for authenticating the communications device 1011. Upon having received the authentication request from the router 1401, the authentication station 1021 transmits, to the communications device 1011, an authentication request (an authentication request from the authentication station) for transmitting authentication data. When having received the authentication request from the authentication station 1021, the communications device 1011 transmits authentication data to the authentication station 1021. The authentication station 1021 receives the authentication data transmitted from the communications device 1011; authenticates the communications device 1011 on the basis of the authentication data; and transmits the result of authentication to the router 1401. When the router 1401 has received the authentication result from the authentication station 1021 and when the communications device 1011 has been authenticated, the global site address or the site local address is delivered to the communications device 1011. When the communications device 1011 has not been authenticated, the link local address is delivered to the communications device 1011. Consequently, the unauthenticated communications device 1011 can receive only the delivery of the link local address, and hence limitations are imposed on communication beyond the router 1401.

### Fifth Embodiment

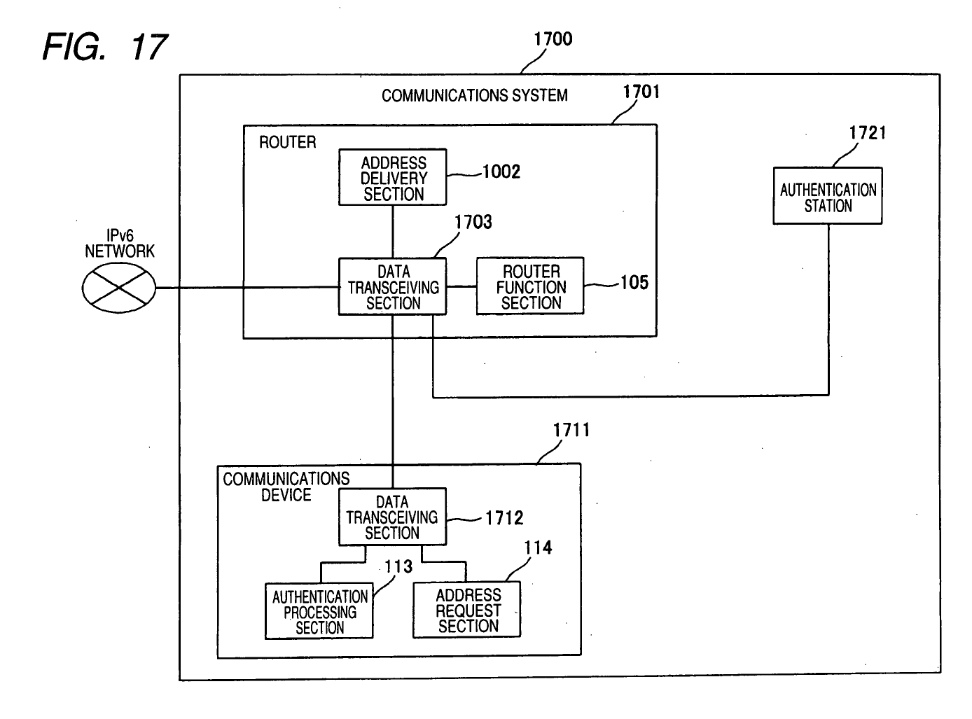

FIG. 17 is a block diagram showing the configuration of a communications system according to a fifth embodiment of the present invention. A communications system 1700 shown in FIG. 17 is constituted as the result of a router 1701 and a communications device 1711 being connected by the IPv6 network and an authentication station 1721 being connected to a dedicated port of the router 1701.

The router 1701 is constituted of the address delivery section 1002 having the function of delivering an IP address to the communications device 1711; a data transceiving section 1703 having the function of transmitting and receiving data by way of the IPv6 network and the function of transmitting and receiving data to and from the authentication station 1721 by way of a dedicated port; and the router function section 105 having the function of an existing router such as determination of a destination of data to be transferred. The data transceiving section 1703 constitutes an authentication data transfer unit for transferring authentication data from the communications device 1711 to the authentication station 1721. The address delivery section 1002 has the same function as that of the counterpart in the third embodiment of the present invention. The router function section 105 has the same function as that in the first embodiment of the present invention.

The communications device 1711 includes a data transceiving section 1712 having the function of transmitting and receiving data by way of the IPv6 network; the authentication processing section 113 having the function of transmitting previously-recorded authentication data; and the address request section 114 having the function of requesting an IP address. The authentication processing section 113 and the address request section 114 have the same functions as do the counterparts in the first embodiment of the present invention.

The authentication station 1721 is connected to a dedicated port of the router 1701. The authentication station 1721 and the router 1701 are connected together by the IPv6 network, which differs from that to which the communications device 1711 is connected. The router 1701 and the authentication station 1721 may be connected together by a communications technique such as an RS232C other than an LAN, or a communications technique such as an IPv4 network other than the IPv6 network.

The authentication station 1721 has the function of receiving a request for authenticating the communications device 1711 from the router 1701; authenticating the communications device 1711 by exchanging authentication data with the communications device 1711 by way of the router 1701; and returning the result of authentication to the router 1701.

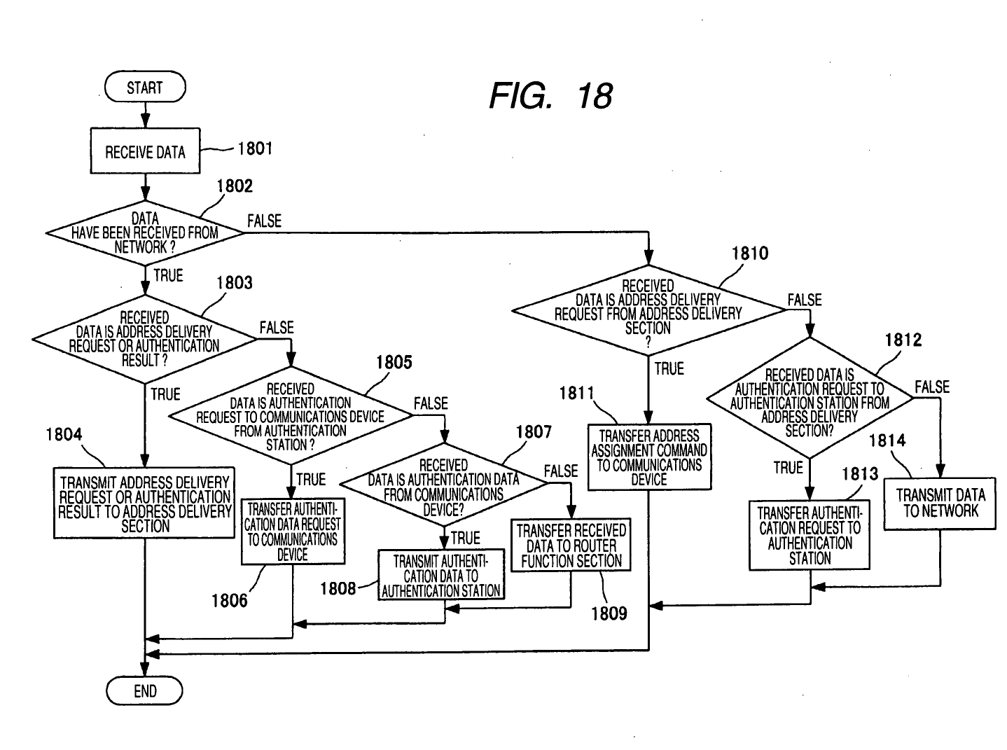

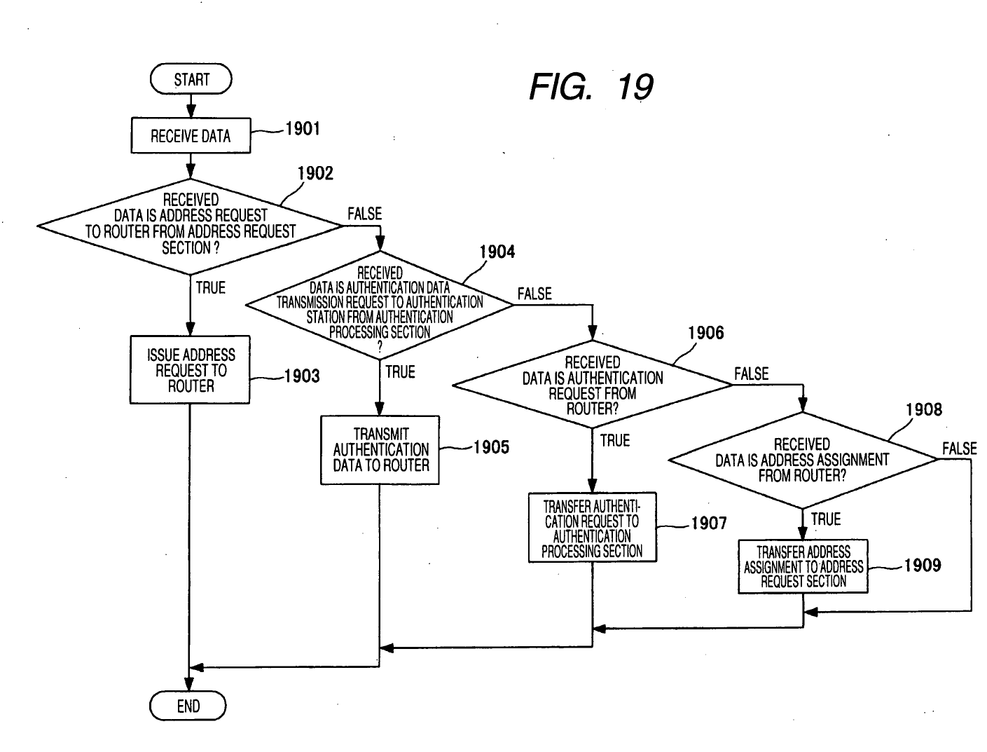

Operation of the router 1701 will now be described. FIG. 18 is a flowchart showing operation of the data transceiving section 1703 of the router 1701. The data transceiving section 1703 of the router 1701 first receives data (step 1801). Next, the data transceiving section 1703 makes a determination whether or not the received data originate from the network (step 1802). When the received data originate from the network, a determination is made as to whether or not the received data are an address delivery request transmitted from the communications device 1711 or the authentication result transmitted from the authentication station 1721 (step 1803). When the result of determination rendered in step 1803 is true, the address delivery request or the authentication result is transmitted to the address delivery section 1002 (step 1804).

When the result of determination rendered in step 1803 is false, a determination is made as to whether the received data are a request for authentication data to the communications device 1711 from the authentication station 1721 (step 1805). When the result of determination rendered in step 1805 is true, an authentication data request is transmitted to the communications device 1711 (step 1806). When the result of determination rendered in step 1805 is false, a determination is made as to whether or not the received data are authentication data output from the communications device 1711 (step 1807). When the result of determination rendered in step 1807 is true, the data transmitted from the device having a link local address are originally not transferred to another port, but only the data used for authenticating a dedicated port connected to the authentication station 1721 are taken as an exception. The authentication data transmitted from the communications device 1711 are transmitted to the authentication station 1721 by way of the dedicated port (step 1808). When the result of determination rendered in step 1807 is false, the received data are transferred to the router function section 105 (step 1809).

When the result of determination rendered in step 1802 is false, a determination is made as to whether or not the received data are an address delivery request transmitted from the address delivery section 1002 (step 1810). When the result of determination rendered in step 1810 is true, an address assignment command is transmitted to the communications device 1011 (step 1811). When the result of determination rendered in step 1810 is false, a determination is made as to whether the received data are an authentication request output from the address delivery section 1002 to the authentication station 1021 (step 1812). When the result of determination rendered in step 1812 is true, the authentication request is transferred to the authentication station 1721 via a dedicated port (step 1813). When the result of determination rendered in step 1812 is false, the received data originate from the router function section 105, and the data are transmitted to the destination specified by the router function section 105 (step 1814).

Operation of the communications device 1711 will now be described. FIG. 19 is a flowchart showing operation of the data transceiving section 1712 of the communications device 1711. The data transceiving section 1712 of the communications device 1711 first receives data (step 1901). Next, a determination is made as to whether or not the received data are an address request transmitted from the address request section 114 to the router 1701 (step 1902). When the result of determination rendered in step 1902 is true, an address request is issued to the router 1701 (step 1903). When the result of determination rendered in step 1902 is false, a determination is made as to whether or not the received data are a request from the authentication processing section 113 to the authentication station 1721 for transmitting authentication data (step 1904). When the result of determination rendered in step 1904 is true, the authentication data are transmitted to the router 1701 (step 1905).

When the result of determination rendered in step 1904 is false, a determination is made as to whether or not the received data are an authentication request from the router 1701 (step 1906). When the result of determination rendered in step 1906 is true, the authentication request is transferred to the authentication processing section 113 (step 1907). When the result of determination rendered in step 1906 is false, a determination is made as to whether or not the received data are an address assignment output from the router 1701 (step 1908). When the result of determination rendered in step 1908 is true, the received data are transferred to the address request section 114 (step 1909). When the result of determination rendered in step 1908 is false, nothing is performed.

In the communications system shown in FIG. 17, when having received the address delivery request transmitted from the communications device 1711, the router 1701 delivers a link local address to the communications device 1711, and transmits to the communications device 1711 an authentication request for requesting transmission of authentication data. The communications device 1711 receives the delivery of a link local address from the router 1701; receives the authentication request transmitted from the router 1701; and transmits the authentication data to the router 1701 through use of the delivered link local address. When having received the authentication data transmitted from the communication device 1711, the router 1701 transmits the received authentication data to the authentication station 1721 by way of the dedicated port. The authentication station 1721 receives the authentication data transmitted from the router 1701; authenticates the communications device 1711 on the basis of the received authentication data; and transmits the result of authentication to the router 1701. When the router 1701 has received the result of authentication and the communications device 1711 has been authenticated, the global address or the site local address is delivered to the communications device 1711. Therefore, the authenticated (normal) communications device 1711 can receive the delivery of a global address or a site local address, and communication beyond the router 1701 becomes feasible. The unauthorized communications device 1711 can receive only the delivery of the link local address, and hence communication beyond the router 1701 is limited.

Each of the routers described in the respective embodiments can be constituted of a computer constituting the router, and a program or a communications method for a communications device which causes the computer to implement the function of the router.

Each of the communications devices described in the respective embodiments can be constituted of a computer constituting the communications device and a router program for causing the computer to implement a function of a router, or a communications method.

According to the embodiment, an authentication function is added to the address delivery function of IPv6, to thus authenticate the communications device. When the device is authorized, a global address or a site local address is delivered. When the device is not authorized, a link local address is delivered. Thus, the load imposed on the device, which would otherwise be caused by periodic verification of a device, is mitigated, and limitations can be imposed on connection of an unauthorized communications device with a network. Further, the present invention can be combined with arbitrary an authentication unit such as a public-key authentication scheme, to thus realize a high degree of security.

The present invention imposes limitations on connection of the unillustrated communications device with the network without involvement of an increase in the load on the router constituting a network or network equipment such as a communications device, to thus yield an advantage of the ability to realize a high degree of security. The present invention is useful in a communications system which performs communication through use of an IPv6 network, a router constituting the communications system, a communications device, a communications method, and a program.

Although the present invention has been described in detail or by reference to the specific embodiments, it is evident for the person skilled in the art that the present invention can be subjected to various alterations or modifications without departing the scope and spirit of the present invention.

The present application is based on Japanese Patent Application (Patent Application No. 2005-005154) filed on Jan. 12, 2005, the content of which is hereby incorporated by reference.
100, 800, 1000, 1400, 1700 communications system
101, 801, 1001, 1401, 1700 router
102 equipment authentication section
103, 803, 1002, 1402 address delivery section
104, 1003, 1403, 1703, 1712 data transceiving section
105 router function section
111, 1011, 1711 communications device
112, 1012, 1712 data transceiving section
113 authentication processing section
114 address request section
1021, 1721 authentication station
1031 hub

1. A communications system for communication through use of an IPv6 network, comprising:
a router; and
a communications device,
wherein the router includes:
an authentication unit that performs authentication upon receipt of authentication data from the communications device;
a first address delivery unit that delivers a link local address to the communications device; and
a second address delivery unit that delivers a global address or a site local address to the communications device when the communications device has been authenticated by the authentication unit; and
wherein the communications device includes:
an address request unit that requests the router to deliver an address; and
an authentication data transmission unit that transmits authentication data to the router.

2. A communications system for communication through use of an IPv6 network, comprising:
a router; and
a communications device,
wherein the router includes:
an authentication unit that performs authentication upon receipt of authentication data from the communications device; and
an address delivery unit that delivers a global address or a site local address to the communications device when the communications device is authenticated by the authentication unit and that delivers a link local address to the communications device when the communications device is not authenticated by the authentication unit; and
wherein the communications device includes:
an address request unit that requests the router to deliver an address; and
an authentication data transmission unit that transmits authentication data to the router.

3. A communications system for communication through use of an IPv6 network, comprising:
a router;
a communications device;
an authentication station having a function of authenticating the communications device; and
a connection section that connects the router, the communications device, and the authentication station,
wherein the router includes:
a first address delivery unit that delivers a link local address to the communications device;
an authentication result receiving unit that receives an authentication result of the communication device from the authentication station; and
a second address delivery unit that delivers a global address or a site local address to the communications device when the authentication result is an approval of an authentication; and
wherein the communications device includes:
an address request unit that requests the router to deliver an address; and
an authentication data transmission unit that transmits authentication data to the authentication station.

4. A communications system, comprising:
a router, that is connected to an IPv6 network;
a communications device; and
an authentication station that is connected to the router,
wherein the router includes:
a first address delivery unit that delivers a link local address to the communications device;
an authentication data transfer unit that transfers, to the authentication station, authentication data which have been transmitted from the communications device by using the link local address; and
a second address delivery unit that delivers a global address or a site local address to the communications device when the communications device has been authenticated by the authentication station; and
wherein the communications device includes:
an address request unit that requests the router to deliver an address, and
an authentication data transmission unit that transmits authentication data to the router.

5. A router used in an IPv6 network, comprising:
a first address delivery unit that delivers a link local address to a communications device connected to the IPv6 network;
an authentication unit that receives authentication data from the communications device and performs authentication; and
a second address delivery unit that delivers a global address or a site local address to the communications device when the communications device has been authenticated by the authentication unit.

6. A router used in an IPv6 network, comprising:
an authentication unit that receives authentication data from a communications device connected to the IPv6 network and performs authentication; and
an address delivery unit that delivers a global address or a site local address to the communications device when the communications device has been authenticated by the authentication unit, and delivers a link local address to the communications device when the communications device has not been authenticated.

7. A router used in an IPv6 network, comprising:
a first address delivery unit that delivers a link local address to a communications device connected to the IPv6 network;
an authentication result receiving unit that receives an authentication result of the communications device from an authentication station connected to the IPv6 network; and
a second address delivery unit that delivers a global address or a site local address to the communications device when the authentication result is an approval of an authentication.

8. A router used in an IPv6 network, comprising:
a first address delivery unit that delivers a link local address to a communications device connected to the IPv6 network;
an authentication data transfer unit that transfers, to an authentication station, authentication data which have been transmitted from the communications device by using the link local address; and
a second address delivery unit that delivers a global address or a site local address to the communications device when the communications device has been authenticated by the authentication station.

9. A communications method for a router used in an IPv6 network, comprising:
delivering a link local address to a communications device connected to the IPv6 network;
authenticating the communications device; and
delivering a global address or a site local address to the communications device when the communications device has been authenticated in the authentication process.

10. A communications method for a router used in an IPv6 network, comprising:
authenticating a communications device connected to the IPv6 network; and
delivering a global address or a site local address to the communications device when the communications device has been authenticated in the authentication process, and delivering a link local address to the communications device when the communications device has not been authenticated.

11. A communications method for a router used in an IPv6 network, comprising:
delivering a link local address to a communications device connected to the IPv6 network;
receiving an authentication result of the communications device from an authentication station connected to the IPv6 network; and
delivering a global address or a site local address to the communications device when the authentication result is an approval of authentication.

12. A communications method for a router used in an IPv6 network, comprising:
delivering a link local address to a communications device connected to the IPv6 network;
transferring, to an authentication station, authentication data that have been transmitted from the communications device by using the link local address; and
delivering a global address or a site local address to the communications device when the communications device has been authenticated by the authentication station.

13. A communications method for a communications device connected to an IPv6 network, comprising:
requests a router to deliver an address, the router connected to the IPv6 network, which derives a link local address when the communications device has not been authenticated, and which delivers a global address or a site local address when the communications device has been authenticated; and
transmitting authentication data to the router.

14. A communications method for a communications device connected to an IPv6 network, comprising:
requests a router to deliver an address, the router connected to the IPv6 network, which delivers a link local address when the communications device has not been authenticated and which delivers a global address or a site local address when the communications device is authenticated; and
transmitting authentication data to an authentication station which authenticates the communications device.
